(19) United States
(12) Patent Application Publication
(10) Pub. No.: US 2026/0291344 A1
(43) Pub. Date: Sep. 24, 2026

(54) Rotor Having a DC-To-DC Converter for an Electric Machine

(71) Applicant: Bayerische Motoren Werke Aktiengesellschaft, Muenchen (DE)

(72) Inventors: Alexander MAIER, Glonn (DE); Yann TREMAUDANT, Muenchen (DE)

(21) Appl. No.: 19/475,303

(22) PCT Filed: Mar. 27, 2024
(86) PCT No.: PCT/EP2024/058323

§ 371 Date: Oct. 14, 2025

(30) Foreign Application Priority Data
Apr. 27, 2023 (DE) 10 2023 110 860.3

(51) Int. Cl. H02K 11/33; B60L 15/04; B60L 15/20; H02K 7/00; H02K 11/25; H02K 13/00; H02M 3/10

(52) U.S. Cl. CPC H02K 11/33; B60L 15/04; B60L 15/20; H02K 7/003; H02K 11/25; H02K 13/003; H02M 3/10; B60L 2210/12; B60L 2240/423; H02K 2211/03

(57) ABSTRACT

A rotor for a current-excited electric machine includes a rotor inductor having one or more electrically conductive rotor windings, and at least one slip ring for providing a slip-ring current to the rotor. The rotor also includes a rotor DC-to-DC converter which is designed to convert the slip-ring current flowing via the slip ring into an excitation current through the rotor inductor, the excitation current being increased by a conversion factor.

### BACKGROUND AND SUMMARY

The present disclosure relates to a rotor for an electric machine, in particular for a current-excited synchronous machine.

An electrically driven vehicle has at least one electric drive machine, which can be designed as a current-excited synchronous machine. The torque produced by the drive machine can depend on the level of the exciter current of the drive machine, wherein as the exciter current rises, the requirements on the design of the brushes and the slip rings which are used for the transmission of the exciter current to the rotor windings of the rotor of the drive machine typically increase. Alternatively or additionally, it may be necessary to increase the number of rotor windings when the level of the exciter current is limited, in order to design the drive machine for a specific target torque.

Increased dimensioning of the slip rings and/or increasing the number of rotor windings lead to increased production costs and possibly to an increased weight of the rotor of an electric machine.

The present document deals with the technical object of providing a particularly efficient rotor for a current-excited electric machine, in particular a rotor which can be produced in a particularly efficient way.

This object is achieved by according to the present disclosure. Advantageous embodiments are also described, inter alia, in the present disclosure. It is pointed out that additional features of a patent claim that depends on an independent patent claim, without the features of the independent patent claim or only in combination with a subset of the features of the independent patent claim, can form an invention that is individual and independent of the combination of all the features of the independent patent claim, which can be made the subject of an independent claim, a partial application or a subsequent application. This applies in the same way to technical teachings that are described in the description, which can form an invention that is independent of the features of the independent patent claims.

According to one aspect, a rotor for a current-excited electric machine (in particular for a synchronous machine) is described. The rotor comprises a rotor inductor having one or more electrically conductive rotor windings. The one or more rotor windings can be arranged around pole shoes of a rotor body (in particular a laminated core) of the rotor.

The rotor further comprises at least one slip ring (typically at least or exactly two slip rings) for providing a slip-ring current to the rotor. The one or more slip rings can be arranged circumferentially on the rotor shaft of the rotor. The electric machine can have brushes which are in contact with the corresponding one or more slip rings, in order to provide the slip-ring current. There may be a slip-ring voltage (in particular a DC voltage) between two slip rings. The slip-ring current over a slip ring is typically a direct current.

The rotor further comprises a rotor DC-to-DC converter, which is designed to convert the slip-ring current flowing via the slip ring into an exciter current through the rotor inductor that is increased by a conversion factor. In other words, the rotor DC-to-DC converter can be designed (e.g. on the basis of the slip-ring voltage) to produce an exciter current through the rotor inductor (i.e. through the one or more rotor windings) which is higher by the conversion factor than the slip-ring current. The rotor DC-to-DC converter can be designed, for example, to effect a conversion factor of 2 or more, in particular of 5 or more.

A rotor is thus described which, by using a DC-to-DC converter, in particular a downward converter, makes it possible to produce a relatively high exciter current through the one or more rotor windings (with a correspondingly reduced exciter voltage) with a relatively low slip-ring current over the one or more slip rings (and a relatively high slip-ring voltage). Thus, the requirements on the current-carrying capacity of the one or more slip rings and the number of rotor windings can be reduced (with a constant target torque of the electric machine). It is thus possible to provide a particularly efficient rotor which, in particular, can be produced in a particularly efficient way.

The rotor DC-to-DC converter can comprise at least one active, in particular semiconductor-based, switching element, which is designed to be opened and closed repeatedly in order to effect a voltage downward conversion, in particular a voltage downward conversion by the conversion factor. The rotor DC-to-DC converter can be designed in such a way that as a result of the (repeated) opening and closing of the active switching element, an exciter current through the rotor inductor is produced which rises when the switching element is closed and falls when the switching element is opened (and which, on a time-based average, is higher by the conversion factor than the slip-ring current). As a result of providing an active switching element, the DC-to-DC conversion and the corresponding boosting of the exciter current can be effected in a particularly efficient way.

The rotor inductor can be a part of the rotor DC-to-DC converter. The rotor DC-to-DC converter can, for example, comprise (in particular be designed as) a switched DC-to-DC converter, in particular a Buck converter, which uses the rotor inductor as a converter inductor. Thus, the DC-to-DC conversion can be effected in a particularly efficient way in the rotor.

The rotor can comprise an energy supply module, which is designed to supply the rotor DC-to-DC converter with electrical energy on the basis of the slip-ring voltage present on the slip ring, in particular on the basis of the slip-ring voltage present between two slip rings. Thus, the efficiency of the rotor can be increased further, since it is possible to dispense with a separate supply of energy to the rotor for the operation of the rotor DC-to-DC converter.

The rotor can be designed to receive a control signal, in particular a control signal modulated onto the slip-ring current. The rotor DC-to-DC converter can be designed to adjust the conversion factor as a function of the control signal.

It is thus possible for the conversion factor to be changed during the operation of the electric machine (e.g. within the context of power regulation for adjusting the torque provided by the electric motor). Thus, particularly efficient and precise operation of the electric machine can be effected.

The rotor DC-to-DC converter, in particular a printed circuit board having the rotor DC-to-DC converter, is preferably arranged directly on the rotor shaft or in a cavity in the (possibly hollow) rotor shaft. Thus, particularly uniform running of the rotor can also be effected when a rotor DC-to-DC converter is provided.

The rotor can comprise a printed circuit board, on which the rotor DC-to-DC converter is arranged. Alternatively or additionally, the rotor can comprise one or more electronic components, in particular a temperature sensor and/or one or more components for the compensation of the electromagnetic field produced by the rotor. The one or more components can be produced on the printed circuit board in a particularly efficient way. Thus, the functionalities of an electric machine can be expanded in an efficient way.

The rotor can have one or more current sensors (e.g. on the printed circuit board), which are each configured to capture measured values of the slip-ring current and/or the exciter current. The rotor can also have one or more electronic components (e.g. on the printed circuit board) for providing current regulation, for example current regulation in order to regulate the slip-ring current and/or the exciter current.

Alternatively or additionally, the rotor (e.g. on the printed circuit board) can have at least one communication unit which is configured to communicate with a communication unit that is arranged outside the rotor. Via the communication unit, data communication can be enabled, for example radio-based, optical and/or Power Line Communication (PLC)-based data communication. A current target value for the current regulation of the slip-ring current and/or the exciter current on the rotor can be provided via the data communication. Alternatively or additionally, measured values from one or more sensors of the rotor can be transmitted (to a receiver outside the rotor) via the data communication. Thus, for example, a diagnosis of the state of the rotor can be enabled.

According to a further aspect, an electric machine, in particular a current-excited synchronous machine, is described, which comprises the rotor described in this document.

According to a further aspect, a (road) motor vehicle (in particular a passenger car or a truck or a bus or a motorcycle) is described, which comprises the electric machine described in this document.

It should be noted that the devices and systems described in this document can be used both on their own and also in combination with other devices and systems described in this document. Furthermore, any aspects of the devices and systems described in this document can be combined with one another in diverse ways. In particular, the features of the claims can be combined with one another in diverse ways. Furthermore, features listed in brackets are to be understood as optional features.

The present disclosure is described in more detail below with reference to exemplary embodiments.

### BRIEF DESCRIPTION OF DRAWINGS

FIG. 1a shows exemplary components of a vehicle having an electric drive machine;

FIG. 1b shows an exemplary inverter or converter and an exemplary device for providing the exciter current for an electric machine of a vehicle;

FIG. 1c shows the exemplary device for providing the exciter current for the rotor of an electric machine;

FIG. 2a shows an exemplary rotor having a DC-to-DC converter, in particular having a downward converter; and

FIG. 2b shows an exemplary rotor in which the rotor inductor is used as the inductor for voltage conversion.

### DETAILED DESCRIPTION OF DRAWINGS

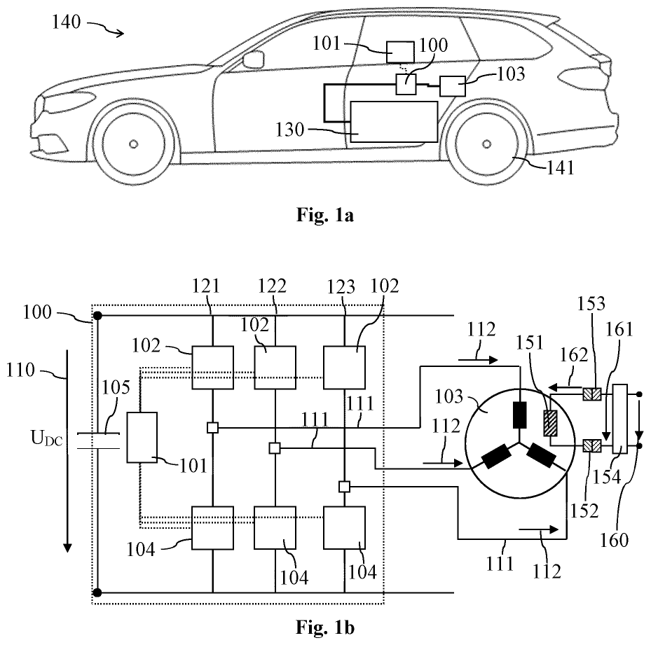

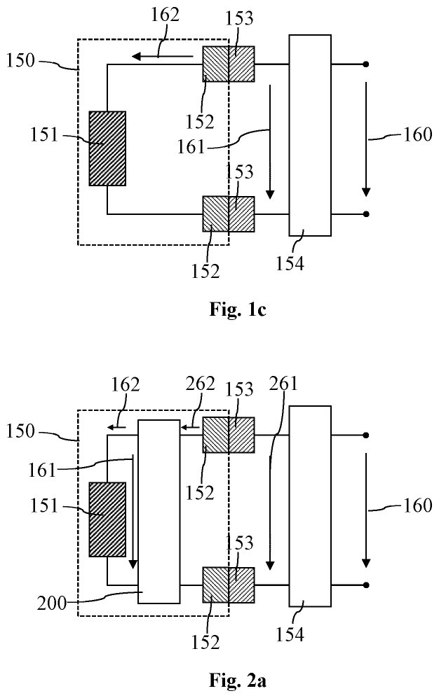

As explained at the beginning, the present document deals with increasing the efficiency of the rotor of a current-excited electric machine. In this connection, FIG. 1 shows exemplary components of a vehicle 140 which has an electric machine 103 for driving the vehicle 140. The electric machine 103 is coupled to one or more wheels 141 of the vehicle 140, in order to drive the one or more wheels 141 and therefore the vehicle 140. The electric machine 103 is operated with electrical energy from an electrical, in particular electrochemical, energy storage device 130. The energy storage device 130 can be designed to provide a direct current with a specific DC voltage.

The vehicle 140 has an inverter 100, which is configured to generate phase currents for the different phases of the electric machine 103 on the basis of the direct current from the energy storage device 130. The inverter 100 can be operated by a (control) device 101.

FIG. 1b shows an exemplary inverter 100, which is configured to generate phase voltages 111 (i.e. AC voltages) for the coils of the electric machine 103 on the basis of a vehicle electrical system voltage UDC 110 (i.e. a DC voltage). The inverter 100 can have an intermediate circuit with an intermediate circuit capacitor 105, to which the vehicle electrical system voltage UDC 110 is applied.

The inverter 100 (or converter) comprises a plurality of switches or switching elements 102, 104 which, in the example illustrated, are respectively arranged in a half-bridge for each phase 121, 122, 123. The switching elements 102, 104 are activated by the (control) device 101 in order to generate the phase voltages 111 for the electric machine 13. The individual phase currents 112 and/or phase voltages 111 can be provided to the electric machine 103 via corresponding phase lines.

The electric machine 103 can have a current-excited rotor, wherein the rotor has rotor windings which are formed by a rotor inductor 151 (as illustrated by way of example in FIGS. 1b and 1c). An electrical exciter current 162 (in particular a DC current) can flow through the rotor inductor 151, so that a magnetic field is generated by the rotor inductor 151, on which the rotating field produced by the stator acts in order to drive the rotor.

The exciter current 162 for the rotor inductor 151 can be provided to the rotor via slip rings 152, wherein the (rotating) slip rings 152 are in contact with (stationary) brushes 153. An exciter voltage 161 (in particular a DC voltage) can be applied to the brushes 153, which produces the exciter current 162. The level of the exciter voltage 161 can be adjusted by a DC-to-DC converter 154, which is designed to generate the exciter voltage 161 from a supply voltage 160 (wherein the supply voltage 160 can correspond to the vehicle electrical system voltage 110).

The level of the exciter current 162 can be adjusted via the level of the exciter voltage 161, e.g. by using current regulation. The torque provided by the electric machine 103 typically rises as the level of the exciter current 162 rises.

The electric machine 103 can be designed for a specific maximum possible target torque. This may make it necessary to design the slip rings 152 for a relatively high exciter current 162. On the other hand, the target torque can make a relatively high number of rotor windings necessary (if the exciter current 162 is to be limited). The design of the electric machine 103 for a relatively high target torque can thus lead to a relatively high outlay in the design of the rotor of the electric machine 103.

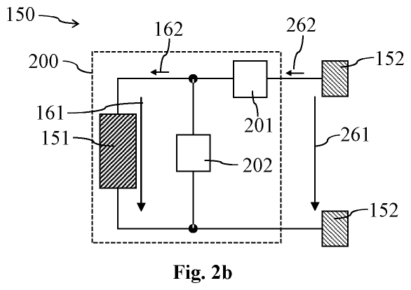

In this document, a rotor is described (as described by way of example in FIGS. 2a and 2b) which has a rotor DC-to-DC converter 200 between the slip rings 153 and the rotor inductor 151. The rotor inductor 151 can advantageously be used for the voltage conversion. FIG. 2a shows a rotor 150 in which a slip-ring voltage 261 (which, for example, is generated by the stationary converter 154) is present between the slip rings 152. A slip-ring current 262 flows via the slip rings 152. The rotor 150 comprises a (rotating) rotor DC-to-DC converter 200, which is configured to generate the exciter voltage 161 on the basis of the slip-ring voltage 261, wherein the exciter voltage 161 is preferably smaller by a specific conversion factor than the slip-ring voltage 261. Thus, a downward conversion by a specific conversion factor can be effected by the rotor converter 200. In a corresponding way, the exciter current 162 which flows through the rotor inductor 151 is increased with respect to the slip-ring current 262 (by the conversion factor) by the rotor converter 200.

Providing a (rotating) rotor converter 200 thus makes it possible, when using a relatively low slip-ring current 262 via the slip rings 152 (to reduce the requirements on the slip rings 152), to produce a relatively high exciter current 162 for the rotor inductor 151 (in order to reduce the number of rotor windings). Thus, a particularly efficient design of the rotor 150 can be made possible.

In a preferred example, the rotor inductor 151 is used directly as part of the rotor converter 200, as illustrated by way of example in FIG. 2b. The rotor converter 200 illustrated in FIG. 2b is designed as a Buck converter, for example, the converter inductor corresponding to the rotor inductor 151. The rotor converter 200 comprises at least one active (semiconductor-based) switching element 201 which can be opened and closed repeatedly in order to effect the voltage conversion. Within a period, the switching element 201 can have respectively (exactly) one open phase, in which the switching element 201 is opened, and respectively (exactly) one closed phase, in which the switching element 201 is closed. The period can have a specific period duration T; the open phase can have an open duration To, and the closed phase can have a closed duration Tg. The conversion factor of the rotor converter 200 can typically be adjusted via the so-called duty cycle, wherein the duty cycle corresponds, for example, to the ratio of the closed duration to the period duration. The switching element 201 can be opened and closed repeatedly in a sequence of successive periods in order to effect the voltage conversion. The rotor converter 200 can thus be a switched voltage converter.

The rotor converter 200 can also have a further (possibly passive) switching element 202 (such as a diode). Furthermore, the rotor converter 200 can optionally have a (smoothing) capacitance, in particular a capacitor.

The rotor converter 200 can possibly be operated with a constant conversion factor (fixed in advance). As a consequence, the switching element 201 can be operated with a constant duty cycle, so that no control signals for the switching element 201 have to be transmitted to the switching element 201 from outside the rotor 150.

On the other hand, it may possibly be advantageous to change the period duration and/or the duty cycle of the switching element 201 during the operation of the electric machine 103. In this case, control signals (e.g. from the (control) device 101) can be transmitted to a driver circuit of the switching element 201 (the driver circuit being arranged on the rotor 150). The control signals can, for example, be modulated onto the slip-ring current 262 (e.g. by using Power Line Communication, PLC, technology). It is thus possible to dispense with the provision of a separate signal line (with a separate slip ring for the signal line).

If the rotor converter 200 can be controlled actively by control signals, the rotor converter 200 can be incorporated in the current regulation for adjusting the exciter current 162. It is thus possible for the (stationary, non-rotating) electronics for generating the exciter current 162 to be simplified, where appropriate.

The rotor 150 can have an energy supply module for the energy supply of the one or more active elements 201 of the rotor converter 200 (which are not illustrated in the figures). The energy for the operation of the energy supply module and/or the one or more active elements 201 of the rotor converter 200 can be provided on the basis of the slip-ring voltage 261 (so that no further energy supply lines from the stationary part of the electric machine 103 to the rotor 150 are needed).

As explained at the beginning, in a current-excited synchronous machine 103 with slip ring 152, the electrical energy for the excitation of the rotor 150 is transmitted via one or more slip rings 152. Since the one or more slip rings 152 have to be dimensioned in accordance with the current 262 to be transmitted, it is typically advantageous to keep the slip-ring current 262 low. If the slip-ring current 262 corresponds to the exciter current 162, this can lead to a relatively high number of windings (i.e. to a relatively large number of parallel conductors) in order to produce the necessary excitation of the rotor 150. The production of a relatively high number of windings from a relatively thin wire is technologically demanding. Furthermore, the mechanical stability and the inductance can be impaired as a result.

In this document, measures are described which permit the production of the required rotor excitation with a relatively low number of windings and a relatively high exciter current 162 in the individual conductors with, at the same time, a relatively low slip-ring current 262, by using a downward converter 200 integrated into the rotor 150.

By the measures described in this document, the current intensity of the power transmission via the one or more slip rings 152 can be kept relatively low. Furthermore, the winding on the rotor 150 can be produced by a relatively low number of windings with a relatively large conductor cross section.

The power (relatively low slip-ring current 262 with a relatively high slip-ring voltage 261) made available to the rotor 150 can be converted on the rotor 150 by a downward converter 200 into a relatively high exciter current 162 with a relatively low exciter voltage 161. The inductor for the downward converter 200 can be represented by the rotor winding itself, i.e. by the rotor inductor 151. The exciter current 162 can be greater than the slip-ring current 262 by the conversion factor of the converter 200. The exciter voltage 161 can be lower than the slip-ring voltage 261 by the conversion factor of the converter 200.

As a result of the measures described in this document, the production of the rotor winding can be simplified. In addition, the strength and the rotational speed of the rotor 150 can be increased. In addition, field quenching around the rotor 150 can be improved (by the reduced inductance). Furthermore, the use of semiconductors on the rotor 150 enables the possibility of additional functions such as, for example, active field quenching and/or a temperature measurement in the rotor 150.

The winding on the rotor 150 can be produced by a rectangular enameled copper wire (with a relatively large cross section). The connection of the windings can be made via a PCB (printed circuit board), e.g. an IMS board (insulated metal substrate circuit board), to which the (possibly complete) electronics are also applied. The PCB can be plugged axially onto the rotor 150. The PCB can then be connected to the one or more slip rings 152.

By the measures described in this document, the costs and/or the weight of the rotor 150 of an electric machine 103 can be reduced without reducing the target torque that can be provided by the electric machine 103.

The present disclosure is not restricted to the exemplary embodiments shown. In particular, it should be noted that the description and the figures are intended to illustrate the principle of the proposed devices and systems only by way of example.

1-12. (canceled)

13. A rotor for a current-excited electric machine, the rotor comprising:
a rotor inductor having one or more electrically conductive rotor windings;
at least one slip ring configured to provide a slip-ring current to the rotor; and
a rotor DC-to-DC converter configured to convert the slip-ring current flowing via the slip ring into an exciter current through the rotor inductor that is increased by a conversion factor.

14. The rotor according to claim 13,
wherein the rotor has at least two slip rings, on which a slip-ring voltage is present, and
wherein the rotor DC-to-DC converter is configured to generate the exciter current on a basis of the slip-ring voltage.

15. The rotor according to claim 13,
wherein the rotor DC-to-DC converter comprises at least one active semiconductor-based switching element that is configured to be opened and closed repeatedly in order to effect a voltage downward conversion by the conversion factor.

16. The rotor according to claim 15,
wherein the rotor DC-to-DC converter is configured so that, as a result of the repeated opening and closing of the active switching element, an exciter current through the rotor inductor is produced that rises when the active switching element is closed and falls when the active switching element is opened.

17. The rotor according to claim 13,
wherein the rotor inductor is part of the rotor DC-to-DC converter.

18. The rotor according to claim 13,
wherein the rotor DC-to-DC converter comprises a switched DC-to-DC Buck converter that uses the rotor inductor as a converter inductor.

19. The rotor according to claim 13, comprising:
an energy supply module configured to supply the rotor DC-to-DC converter with electrical energy on a basis of a slip-ring voltage present between two slip rings of the at least one slip ring.

20. The rotor according to claim 13,
wherein the rotor is configured to receive a control signal modulated onto the slip-ring current, and
wherein the rotor DC-to-DC converter is configured to adjust the conversion factor as a function of the control signal.

21. The rotor according to claim 13,
wherein the rotor has a rotor shaft, and
wherein a printed circuit board having the rotor DC-to-DC converter is arranged directly on the rotor shaft or in a cavity in the rotor shaft.

22. The rotor according to claim 13,
wherein the rotor DC-to-DC converter is configured to effect a conversion factor of 2 or more.

23. The rotor according to claim 13 comprising:
a printed circuit board, on which the rotor DC-to-DC converter is arranged; and
one or more electronic components comprising a temperature sensor and/or one or more components for compensation of an electromagnetic field produced by the rotor, which are arranged on the printed circuit board.

24. A current-excited synchronous machine comprising:
the rotor according to claim 13.
